(19) United States
(12) Patent Application Publication
(10) Pub. No.: US 2005/0033949 A1
(43) Pub. Date: Feb. 10, 2005

(54) Test method, test receptacle and test arrangement for high-speed semiconductor memory devices

(76) Inventors: Konrad Herrmann, Muenchen (DE); Andreas Schellinger, Muenchen (DE); Peter Mayer, Neubiberg (DE); Markus Rohleder, Muenchen (DE)

Correspondence Address: SLATER & MATSIL LLP, 17950 PRESTON ROAD, SUITE 1000, DALLAS, TX, 75252, US

(21) Appl. No.: 10/850,373

(22) Filed: May 21, 2004

(30) Foreign Application Priority Data
May 23, 2003 (DE) 103 23 413.6

(51) Int. Cl. G06F 9/00

(52) U.S. Cl. 713/1

(57) ABSTRACT

For testing high-speed semiconductor memory devices (1) with a high data transfer rate, for instance DDR-DRAMs, controller modules (24) are provided in or as a constituent part of test receptacles (2) that are to be populated by a supply and handling system (3), said controller modules functionally essentially corresponding to customary graphic controllers. Components of the DRAMs (1) which determine the data transfer rate thereof are tested by means of the controller modules (24) at the supply and handling system (3), which is suitable for the high-volume throughout the DRAMs (1).

### BACKGROUND

1. Field

The following relates to a test method for semiconductor memory devices provided for operation with a memory control unit on a memory assembly by means of a test apparatus.

2. Background Information

High-volume testing of semiconductor memory devices, for instance DRAMs (dynamic random access memories), after the production thereof is effected at test arrangements having an automated tester system (tester) and a supply and handling system (handler). The semiconductor memory devices to be tested are taken from magazines by the supply and handling system, supplied to a respective test receptacle and introduced into the latter for electrical contact-connection in a manner free of soldering. During testing, the supply and handling system sets and controls ambient conditions under which the testing is to be carried out, for instance an ambient temperature. After testing, the tested semiconductor memory devices are sorted by the supply and handling system in accordance with a test result.

The tester system is arranged in the vicinity of the supply and handling system. The test signals required for testing the semiconductor memory devices are generated and data signals output in the course of testing by the semiconductor memory devices to be tested are evaluated in the tester system. For this purpose, electrical connecting lines are led from the tester system to a test head which is assigned to the supply and handling system and is largely not specific to devices under test. An adapter unit (Hifix) carrying the test receptacles imparts an electrical connection between the semiconductor memory devices to be tested, which are arranged in the test receptacles, and the test head which is not specific to devices under test. The test receptacles are adapted to a housing form of a respective type of semiconductor memory devices to be tested. In the simplest case, the adapter unit has only a wiring specific to devices under test between the test receptacles and an interface to the test head.

The requirements made of the performance of the test arrangements of the type described rise as the maximum clock frequency of the semiconductor memory devices to be tested increases. Thus, at the present time, clock frequencies of 600 MHz are realized on graphics cards for PCs with respect to a data transfer rate between a graphic memory and a graphic controller which manages image data stored in the graphic memory. A data rate of 1200 Mbits/sec then results relative to a data signal for semiconductor memory devices with a DDR (double data rate) interface as data transfer interface. Testing a timing behavior, in particular that of the data transfer interface for receiving and for outputting data signals of the high speed semiconductor memory devices, requires a higher internal clock frequency relative to the clock frequency of the semiconductor memory device to be tested for operation of the test signal unit of the tester system, in order that the data signals output by the semiconductor memory devices are temporally resolved with sufficient accuracy and impermissible deviations in the timing behavior are distinguished sufficiently accurately from deviations (timing margins) that are permissible in accordance with a specification. A time expenditure required for developing and testing such complex and specialized tester systems has the effect that initially no suitable tester systems are available for a relatively long period of time for in each case what are actually the fastest semiconductor memory devices available.

Therefore, the semiconductor memory devices are initially usually tested with greater severity than is necessary in accordance with the specifications. The testing with greater severity leads to a high loss of yield of semiconductor memory devices which are rated as defective in the test even though they fulfill the specifications.

A further problem posed is that of preserving the signal integrity of the test and data signals transferred between the tester system and the test head or the test receptacles.

Currently, tester systems or test arrangements for high-volume testing of high speed semiconductor memory devices with a clock frequency of more than 533 MHz are expensive and available with difficulty.

### SUMMARY

Therefore, the present invention is based on the object of providing a test method which enables high-volume testing of a data transfer interface of high-speed semiconductor memory devices with a minimum of losses of yield attributable solely to the test environment. Furthermore, the invention is based on the object of providing a test receptacle and a test arrangement which make such a test method possible.

A test method is described for semiconductor memory devices provided for operation with a memory control unit on a memory assembly by means of a test apparatus. A respective one of the semiconductor memory devices is introduced by means of a supply and handling system into a test receptacle with a respective module interface for receiving and making contact with the semiconductor memory device and a tester interface for connection to the test apparatus. The semiconductor memory device is connected to a test signal unit of the test apparatus via a test signal bus and is stimulated for outputting data signals onto the test signal bus. The data signals output by the semiconductor memory device are detected and evaluated by the test signal unit. The result of the evaluation is transferred to a test control unit which is connected to the test signal unit and controls a test sequence. A memory control unit or a simplified memory control unit derived from a memory control unit is provided as test signal unit and is integrated into the test receptacle as a constituent part thereof.

Further advantages, features and details of the invention emerge from the exemplary embodiments described below.

### BRIEF DESCRIPTION OF THE FIGURES

The invention is explained in more detail below with reference to the drawings, identical reference symbols being used for mutually corresponding structural parts and components. In the figures:

FIG. 1 shows a schematic illustration of a conventional test arrangement,

FIG. 2 shows a schematic illustration of a test arrangement according to the invention according to a first exemplary embodiment,

FIG. 3 shows a schematic illustration of a test arrangement according to the invention according to a second exemplary embodiment,

FIG. 4 shows a schematic cross section through a test receptacle according to the invention according to a first exemplary embodiment, and

FIG. 5 shows a schematic cross section through a test receptacle according to the invention according to a second exemplary embodiment.

### DETAILED DESCRIPTION

The following symbols and elements are used consistently throughout the text and drawings:
1 Semiconductor memory device
2 Test receptacle
2′ Test receptacle
20 Module receptacle
21 Module interface
22 Tester interface
23 Printed circuit board
24 Controller module/memory control unit
25 Cooling unit
3 Supply and handling system
31 Test head
32 Adapter unit (Hifix)
321 Receptacle Unit
33 Basic mounting plate
4 Test apparatus
40 Test control unit
40′ Data processing apparatus
41 Test signal unit
42 Bus multiplexer unit
51 Test signal bus
51′ Test signal bus
52 Control bus
53 Standard bus system
53′ Multiplex standard bus system

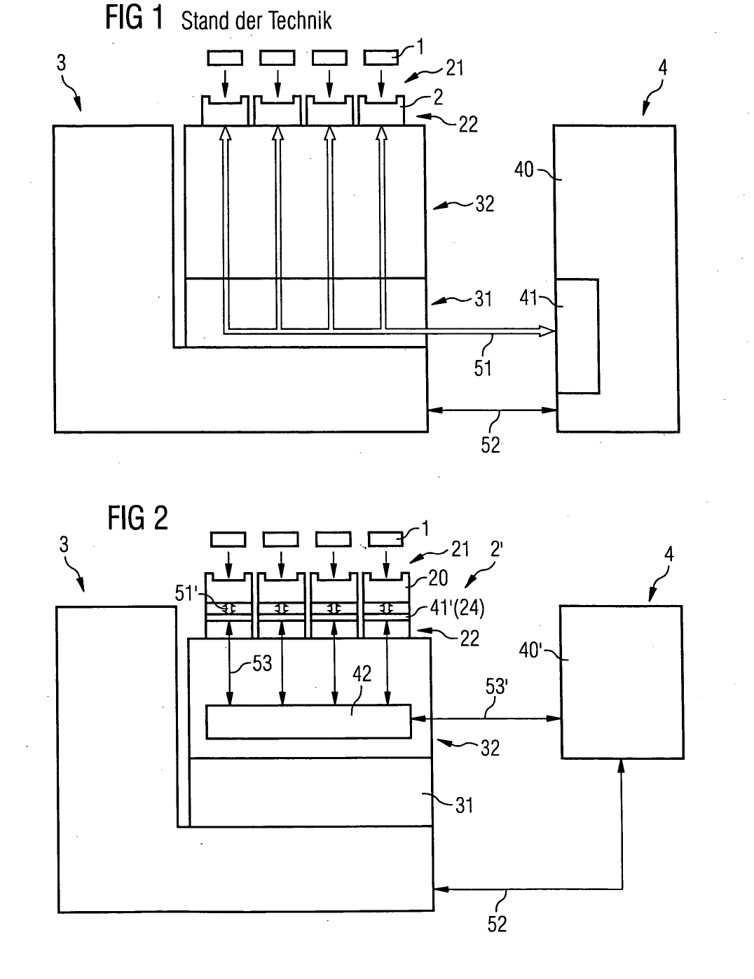

FIG. 1 schematically illustrates a test arrangement that is customary for testing semiconductor memory devices 1. In this case, the test arrangement comprises an automatic supply and handling system 3, which supplies the semiconductor memory devices 1 to be tested to test receptacles 2 and provides them in each case at a module interface 21 of the test receptacle 2. During the test, the supply and handling system 3 controls the ambient parameters required for the testing, in particular the ambient temperature. After the test, the semiconductor memory devices 1 are sorted depending on an individual test result by means of the supply and handling system 3.

Generation of test data or test signals and evaluation of data signals output by the semiconductor memory devices 1 are effected in each case in a remote test apparatus 4, for instance a tester system. The tester system 4 comprises a test control unit 40 and a test signal unit 41. In the test signal unit 41, test signals are generated and transferred via a test signal bus 51 to the semiconductor memory devices 1 to be tested, which are arranged in the test receptacles 2, and data signals output by the semiconductor memory devices 1 on the test signal bus 51 are received and evaluated. The test control unit 40 controls the test signal unit 41 and, in the context of a test sequence for the semiconductor memory devices 1, via a control bus 52, the supply and handling system 3. The test signal bus 51 is routed via a test head 31 that effects communication between the tester system 4 and the supply and handling system 3.

An adapter unit 32 forms an electrical and mechanical interface between the test receptacles 2, which are specific to devices under test, and the test head 31, which is largely not specific to devices under test. The test receptacles 2 in each case have, in addition to the module interface 21 for receiving and making contact with the semiconductor memory device 1 to be tested, a tester interface 22 for connection to the test apparatus 4 or elements of the test apparatus 4 via the test head 31.

In accordance with the exemplary embodiment illustrated in FIG. 2, the test arrangement according to the invention differs from the known test arrangement illustrated in FIG. 1 through the provision of memory control units 24, as are provided in the application of the semiconductor memory devices 1, or of simplified, functionally reduced memory control units 24 as modified test control units 41′, and also through the arrangement thereof in direct proximity to the respectively assigned semiconductor memory device 1 as a constituent part of a modified test receptacle 2′. A resulting modified test signal bus 51′ is significantly shortened and non critical with respect to the test signal bus 51 of the test arrangement of FIG. 1. Graphic controllers or simplified graphic controllers are in each case provided as memory control units 24 in the modified test receptacles 2′ or as a constituent part of the modified test receptacles 2′. The semiconductor memory devices 1 are in each case to be introduced by the supply and handling system 3 in a component receptacle 20 of the test receptacle 2′. The component receptacle 20 is connected to the graphic controller 24 of the test receptacle 2′ in such a way that the semiconductor memory devices 1 introduced in the component receptacles 20 can be operated by the graphic controllers 24.

The semiconductor memory devices 1 introduced in the component receptacles 20 are tested in the context of a test sequence by a test program executed in the graphic controllers 24 or by means of control commands transferred to the graphic controllers 24. The control of the supply and handling system 3 in the course of a test sequence controlled by a data processing apparatus 40′ is effected via a control bus 52 connected to a standardized interface of the data processing apparatus 40′.

A tester interface 22 between the test receptacle 2′ and a part of the test apparatus 4 that is remote from devices under test is formed at least partly as an interface to a standard bus system, for instance an AGP bus system given the provision of graphic controllers 24 as test signal units 41′. If a system circuit board 40′ of a customary data processing apparatus, for instance of a PC, is furthermore provided as test control unit, then the test arrangement is based on widespread, cost-effective components which enjoy the availability of a wide range of tools for adapting them to the requirements within the test arrangement. For the essentially simultaneous testing of a plurality of semiconductor memory devices 1, a bus multiplexer unit 42 is provided between the test receptacles 2′ and the system circuit board 40′, and enables a plurality of standard bus systems to be connected to the standard bus system interface of the system circuit board 40′.

For testing, the test program executed in the graphic controllers 24 is prepared in the data processing apparatus 40′ and transferred simultaneously to the graphic controllers 24 connected to the bus multiplexer unit 42. The graphic controllers 24 subsequently test the semiconductor memory devices 1 essentially simultaneously in accordance with the test program. Patterns for test data, a clock frequency, signal and trigger levels and also an offset of signal edges with respect to one another are altered in the course of the test program. The ambient temperature is set by the supply and handling system 3. The test results of the graphic controllers 24 are transferred to the data processing apparatus 40′ after the test programs have been executed.

Supply voltages, for instance a voltage VDD for supplying internal circuits of the semiconductor memory devices and a voltage VDDQ for supplying output drivers of the data transfer interface of the semiconductor memory device, are set in the test sequence by means of controllable voltage supplies in accordance with the specifications. If this requires further auxiliary circuits, for instance as a constituent part of the test receptacles 2′, then the control thereof is effected either by the graphic controllers 24 in the context of the test program stored in the graphic controllers 24 or by means of additional controller units with an interface to the standard bus system or a further interface to a sub-control bus routed in parallel with the standard bus system. If necessary, the test receptacles 2′ can additionally be connected via the test head 31 for instance to auxiliary circuits or a tester system.

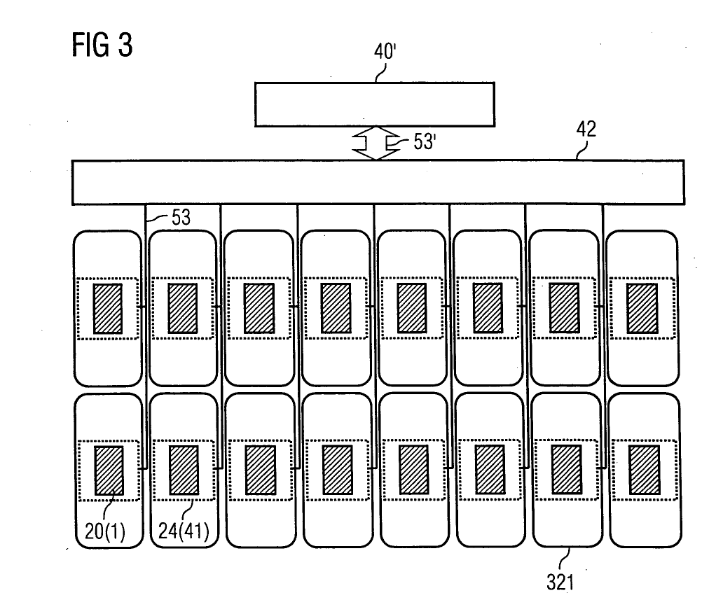

FIG. 3 shows a diagrammatic plan view of an adapter unit 32 with a plurality of test receptacles 2′. A respective receptacle unit 321 of the adapter unit 4 is assigned, in each case as a constituent part of the test receptacle 2′, a component receptacle 20 for population with a semiconductor memory device 1 and a test control 41 formed as a graphic controller 24. Each graphic controller 24 is connected to a bus multiplexer unit 42 via an AGP bus system. The bus multiplexer unit 42 bundles the AGP bus systems in the direction of a data processing apparatus 40′, provided as a test control unit, to form a multiplex AGP bus system 53′. The bus multiplexer unit 42 is arranged within the adapter unit 4, for the case where the adapter unit 4 is only provided as a basic mounting plate, on the basic mounting plate of the adapter unit 4 or in the region of the data processing apparatus 40′.

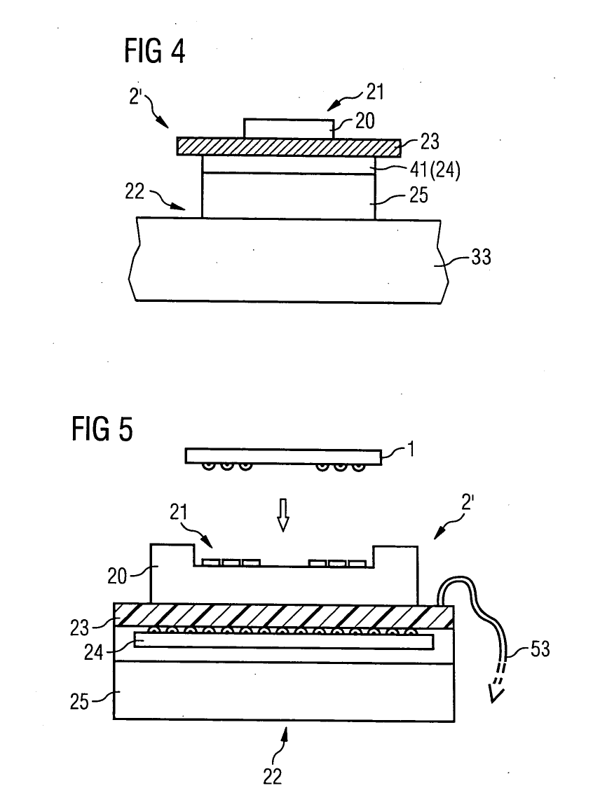

In the exemplary embodiment of a test receptacle 2′ as illustrated in FIG. 4, the test receptacle 2′ is arranged on a basic mounting plate 33 of an adapter unit. A module receptacle 20 forms a module interface 21 of the test receptacle 2′. The module receptacle 20 is arranged opposite to a graphic controller 24 in the function of a test signal unit 41 at a printed circuit board 23. By means of conductor tracks provided on or in the printed circuit board 23, the graphic controller 24 and contact elements of the module receptacle 20 are connected to one another in such a way that a semiconductor memory device 1 introduced in the module receptacle 20 can be operated by the graphic controller 24. A cooling unit 25, for instance a fan, acts on the graphic controller 24 and decouples it thermally from the semiconductor memory device 1 introduced in the module receptacle 20. A tester interface 22 as a connection to further parts of the test apparatus is oriented towards the basic mounting plate 33 in this exemplary embodiment.

By contrast in FIG. 5, an AGP bus system 53 routed onto the printed circuit board 23 forms at least part of the tester interface 22.

In the case of a method of the type mentioned in the introduction, this object is achieved by means of the features specified in the characterizing part of patent claim 1. A test receptacle which achieves the object is specified in patent claim 6 and a test arrangement assigned to achieving the object is specified in patent claim 11. Advantageous developments emerge from the respective subclaims.

Accordingly, a test method according to the invention relates to high-speed semiconductor memory devices which are suitable in their intended application for joint operation with a memory control unit on a memory assembly. In this case, the memory control unit is provided in the application together with one or more semiconductor memory devices on a printed circuit board of the memory assembly. What is important in this case is that at least one data signal bus is routed directly, without signal conditioning means (buffer) or temporary storage means (register), between the corresponding data transfer interfaces of the memory control unit and the semiconductor memory device. Signal conditioning means and temporary storage means are customary for instance for semiconductor memory devices arranged on memory modules (DIMMs, dual inline memory modules) for main memories of standard computer systems such as PCs at high data transfer rates.

The semiconductor memory devices are tested by means of a test apparatus, a respective one of the semiconductor memory devices being introduced by means of a supply and handling system into a test receptacle having a respective module interface for receiving and making contact with the semiconductor memory device and a tester interface for connection to the test apparatus. The semiconductor memory device is connected to a test signal unit of the test apparatus via a test signal bus and is stimulated for outputting data signals onto the test signal bus by the test signal unit. The data signals output by the semiconductor memory device are detected and evaluated by the test signal unit. The result of the evaluation is transferred to a test control unit which is connected to the test signal unit and controls a test sequence.

According to an embodiment of the invention, a memory control unit or a simplified memory control unit derived from a memory control unit is provided as test signal unit and is arranged in direct proximity to the semiconductor memory device that is to be tested in each case within the test receptacle.

In the simplest case, the memory control unit provided as test signal unit corresponds to a memory control unit from an intended application of the semiconductor memory device to be tested, for instance a graphic controller for graphics cards of customary data processing apparatuses such as PCs. Internally, customary memory control units are constructed from a plurality of function blocks, only some of which are required for testing the semiconductor memory device. From such a memory control unit, it is possible to derive a simplified memory control unit as an ASIC (application-specific integrated circuit) using customary technology. The simplified memory control unit may have additional components required for testing the semiconductor memory device. By comparison with alterations to the complex tester systems, the design and production of a simplified memory control unit are comparatively uncomplicated and also rapid and cost-effective to implement.

A test in particular of the functional units which determine the high-speed properties of the semiconductor memory devices, for instance of data transfer interfaces or output drivers for data signals output at the data transfer interface, is then not effected on high-speed tester systems, but rather by means of a test arrangement in which the test control unit of the type of a memory control unit that operates the semiconductor memory device in the application is provided and integrated into a test environment suitable for high-volume testing of the semiconductor memory devices. This enables a regular adaptation of the testability of an upper speed limit of the semiconductor memory devices to be tested to the clock frequency provided by the application and adapts a functional test to a test construction suitable for high-volume testing of semiconductor memory devices.

The invention furthermore utilizes the properties and resources of customary memory control units. An internal clock frequency of memory control units, for instance graphic controllers embodied using logic technology, is usually higher than the clock frequency provided for the data transfer to the semiconductor memory device. The internal clock frequency and time intervals between signal edges of critical signals are programmable to a limited extent for the purpose of testing the graphic controller and for adapting the graphic controller to a circuitry. According to the invention, this property of the memory control units is utilized to the effect that data signals are output such that they are suitable for testing the high speed semiconductor memory devices.

In accordance with the test program executed in the graphic controller, in a known manner, suitable test data are generated by the graphic controller and transferred as test signals to the semiconductor memory devices. The test data are stored in the semiconductor memory devices and, in the further progression, output as data signals which the graphic controller receives and assesses and evaluates in comparison with the original test data.

Periodic calibration runs are generally prescribed for tester systems, in the course of which the test signals output by the tester systems are continuously adjusted with regard to their timing behavior, their level and a propagation time on test signal lines of a test signal bus that are provided for transferring the test signals. Since the properties of the test signal lines can change upon each intervention in the signal path of the test signals, renewed calibration is necessary after every such intervention, for instance a new installation of an adapter unit or a reactivation of a system part after a shutdown time. Since, according to the invention, the test signal bus is formed only in the region of or within the test receptacle, the number of possible triggers for a calibration is reduced. Furthermore, a tester system is not absolutely necessary for the calibration and, therefore, does not necessarily entail an outage time of a tester system.

Signal and trigger levels in particular of the data signals are tested by means of a corresponding programming of the memory control units operated as test signal units. The possibility for this results, in a manner similar to that above, from the fact that in customary memory control units such as graphic controllers, for instance, for the purpose of adapting the memory control unit to different environments, both the trigger level for received signals and the signal level for output signals can be programmed to a limited extent. If the trigger or signal levels which are necessary for the specification of the semiconductor memory devices cannot directly be set sufficiently accurately by means of a corresponding programming of the graphic controllers, then a test temperature is preferably chosen in such a way that a test carried out with a test level for signal or trigger levels at the test temperature is essentially equivalent to a test with the specified levels at the ambient temperature specified for the test. It is advantageous for this purpose for the memory control units to be thermally decoupled from the semiconductor memory devices to be tested by the operation of fans, preferably provided as a constituent part of the test receptacles.

A test program which preferably controls the outputting of the test data by the memory control units, the reading back thereof from the semiconductor memory devices, and also the assessment thereof in the memory control units advantageously runs independently of a tester system. For this purpose, the test program for the memory control unit is preferably stored in each case in a memory control program memory assigned to the memory control unit.

The test method is preferably carried out on test arrangements with a supply and handling system having a test head as an interface—independent of the type of a semiconductor memory device to be tested—to a tester system or to a test apparatus and an adapter unit for mechanical and electrical connection of at least one test receptacle to the test head.

In accordance with a preferred embodiment of the method according to the invention, the memory control unit is controlled by the test control unit of the test apparatus via a standard bus system, for instance via a graphics card bus system. Customary memory control units are provided with such an interface to a standard bus system, for instance graphic controllers via an accelerated graphic port (AGP) as an interface to an AGP bus system. A data processing apparatus which likewise has an AGP, for instance a system circuit board of a PC, is then advantageous as the test control unit. Since generation of test signals and reception and evaluation of data signals output by the semiconductor memory devices are already effected in the memory control units, the highly complex tester system that is usually to be provided is advantageously replaced by a cost-effective PC.

If a plurality of test receptacles are provided, then the standard bus systems respectively assigned to one of the test receptacles are preferably combined into a multiplex standard bus system by a bus multiplexer unit, so that a plurality of memory control units, that is to say graphic controllers, for instance, can be controlled simultaneously by the test control unit, or the PC system circuit board. A test program which can be executed in the memory control units is simultaneously transferred from the test control unit to the memory control units, or to program memories assigned thereto. The memory control units consequently process the test program respectively assigned to them essentially simultaneously and transfer the result to the test control unit via the bus multiplexer unit, so that a plurality of semiconductor memory devices can advantageously be tested simultaneously.

The method according to the invention is fundamentally suitable for all types of semiconductor memory devices. However, it is advantageous in particular, when testing data transfer interfaces of high-speed DRAMs having in each case a data strobe terminal for a data strobe signal and having data terminals for bi-directional data signals synchronized with the data strobe signal. In the case of DDR DRAMS (double data rate DRAMs), for instance, data are transferred both on the falling edge and on the rising edge of the clock signal. A signal “data query strobe” DQS derived from the customary clock signal CLK is used for synchronizing a data transfer from and to a semiconductor memory device with a DDR interface as data transfer interface. DQS corresponds to a data strobe signal which, during the reading of data from a semiconductor memory device, is generated in a manner analogous to the data signals DQ from the semiconductor memory device and, during the writing of data to the semiconductor memory device is generated in a manner corresponding to the data signals DQ from the memory control unit. During reading from the semiconductor memory device, DQS is generated edge-synchronously with the data signals DQ. The memory control unit expects the data on the data lines after each edge at DQS.

During the read-out of data from the semiconductor memory devices, customary tester systems designed and embodied for a semiconductor memory device without a DDR interface assess a data signal synchronously with a read operation controlled by the tester system itself. In the application, however, a higher data transfer rate between the semiconductor devices and the memory control unit is made possible precisely by the synchronization of the data transfer with the data strobe signal. However, a speed sorting of the semiconductor memory devices, which takes account of this advantage, is not possible by means of the customary tester systems. By contrast, if a speed selection of the semiconductor memory devices with a DDR interface is effected by a memory control unit operated as a test control unit, then the data signals DQ are actually assessed in accordance with the application synchronously with DQS. The semiconductor memory devices can be classified in accordance with their actual maximum frequency. A proportion of semiconductor memory devices which can be assigned to a higher speed class is advantageously increased in this way.

The method described can be carried out by means of a test receptacle according to the invention.

A test receptacle for testing semiconductor memory devices, provided for operation with a memory control unit on a memory assembly, by means of a test apparatus and a supply and handling system has a module interface for receiving and making contact with the semiconductor memory device, and a tester interface for connecting the test receptacle to an element of the test apparatus.

According to the invention, the test receptacle comprises a memory control unit or a simplified memory control unit derived from a memory control unit, which is connected to a semiconductor memory device provided at the module interface of the test receptacle in such a way that the semiconductor memory device assigned to the test receptacle can be operated by the memory control unit or the simplified memory control unit.

With regard to its electrical properties, the tester interface is preferably formed in the manner of a graphics card interface, for instance as an AGP.

For the thermal decoupling of the memory control unit from the semiconductor memory device to be tested during a test sequence in the course of which a test can be effected at different temperatures, the test receptacle advantageously comprises a cooling device, for instance a fan, which acts on the memory control unit or the simplified memory control unit.

The test receptacle is preferably provided with a printed circuit board, on the first placement side of which is arranged a module receptacle—to be populated by the supply and handling system—with contact elements for making contact with the semiconductor memory device in a manner free of soldering and on the second placement side of which—opposite to the first placement side—the memory control unit or simplified memory control unit is arranged.

A test arrangement according to the invention enables testing of semiconductor memory devices which, together with memory control units, are intended for operation of memory assemblies. The test arrangement comprises a supply and handling system for the automated supply of semiconductor memory devices to be tested and also a test apparatus having a test control unit for controlling a test sequence and having a test signal unit. The test signal unit is connected to the test control unit and, via a test system bus, to the semiconductor memory device to be tested and is suitable for outputting test signals and also for receiving data signals output by the semiconductor memory device. A further constituent part of the test arrangement is at least one test receptacle for receiving and making contact with one of the semiconductor memory devices to be tested. In this case, according to the invention, the test receptacle is formed in the manner described above.

The memory control unit is preferably connected via a standard bus system to a test control unit which is formed as a standardized data processing apparatus.

The test arrangement according to the arrangement preferably comprises a bus multiplexer unit arranged between the test receptacles and the data processing apparatus. The bus multiplexer unit has a plurality of interfaces to the standard bus systems to the memory control units and a further interface to a standard bus system to the data processing apparatus. The bus multiplexer unit distributes a test program output by the data processing apparatus via the standard bus system or control commands in parallel to the connected test receptacles, or memory control units. The memory control units communicate a good/poor information item relative to the tested semiconductor memory devices to the bus multiplexer unit. The bus multiplexer unit takes up the results of the test in parallel and forwards them to the data processing apparatus for further evaluation and processing.

To a large degree simultaneous testing of a plurality of semiconductor memory devices is thus advantageously made possible.

An embodiment of the test arrangement using conventional or simplified memory control units (graphic controllers) makes it possible to realize rapidly the testing of semiconductor memory devices at least with regard to a speed of a data transfer interface independently of the availability of suitable tester systems and to adapt to it continually changing applications. Components of the data transfer interface which determine the speed of the semiconductor memory device are tested without complicated conversion of existing tester systems.

The forgoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

1. A test method for semiconductor memory devices provided for operation with a memory control unit on a memory assembly by means of a test apparatus, comprising:
introducing a respective one of the semiconductor memory devices by means of a supply and handling system into a test receptacle with a respective module interface for receiving and making contact with the semiconductor memory device and a tester interface for connection to the test apparatus;
connecting the semiconductor memory device to a test signal unit of the test apparatus via a test signal bus and stimulating for outputting data signals onto the test signal bus;
detecting and evaluating the data signals output by the semiconductor memory device by the test signal unit; and
transferring the result of the evaluation to a test control unit which is connected to the test signal unit and controls a test sequence,
wherein a memory control unit or a simplified memory control unit derived from a memory control unit is provided as test signal unit and is integrated into the test receptacle as a constituent part thereof.

2. The method as claimed in claim 1,
wherein the supply and handling system is provided with a test head as an interface to the test apparatus that is independent of the type of a semiconductor memory device to be tested, and with an adapter unit for mechanical and electrical connection between at least one test receptacle and the test head.

3. The method as claimed in claim 1,
wherein the test signal unit is controlled by the test control unit of the test apparatus via a standard bus system.

4. The method as claimed in claim 3,
wherein a plurality of test receptacles are in each case provided and the standard bus system respectively assigned to one of the test receptacles is combined into a multiplex standard bus system by a bus multiplexer unit,
a corresponding plurality of semiconductor memory devices are provided in the test receptacles, and
the semiconductor memory devices provided in the test receptacles are tested largely simultaneously.

5. The method as claimed in claim 1, wherein DRAMS having in each case a data strobe terminal for a data strobe signal and having data terminals for bi-directional data signals that are synchronized with the data strobe signal are provided as semiconductor memory devices to be tested.

6. A test receptacle for testing semiconductor memory devices, provided for operation with a memory control unit on a memory assembly, by means of a test apparatus and a supply and handling system, comprising:
in each case a module interface for receiving and making contact with the semiconductor memory device; and
a tester interface for connection to the test apparatus, including a controller module, which is formed in the manner of the memory control unit or in the manner of a simplified memory control unit derived from the memory control unit and is connected to the module interface in a manner suitable for operation of the semiconductor memory device to be tested.

7. The test receptacle as claimed in claim 6, including a tester interface formed in the manner of a graphics card interface.

8. The test receptacle as claimed in claim 6, including a cooling unit which acts on the controller module and is essentially thermally decoupled from a semiconductor memory device that can be provided at the module interface.

9. The test receptacle as claimed in claim 6,
wherein the module interface is integrated into a module receptacle that can be populated by the supply and handling system.

10. The test receptacle as claimed in claim 6, including
a printed circuit board on the first placement side of which the module receptacle is arranged and on the second placement side of which, opposite to the first placement side, the controller module is arranged.

11. A test arrangement for testing semiconductor memory devices which are provided together with memory control units for operation on memory assemblies, comprising:
a supply and handling system for the automated supply of semiconductor memory devices to be tested;
at least one test receptacle for receiving and making contact with a respective semiconductor memory device that is to be tested and is supplied by the supply and handling system; and
a test apparatus having a test control unit for controlling a test sequence and a test signal unit, connected to the semiconductor memory device to be tested via a test signal bus for outputting test signals and for receiving data signals output by the semiconductor memory device.

12. The test arrangement as claimed in claim 11, wherein the test signal unit is connected to the test control unit, provided as a standardized data processing apparatus, via a standard bus system.

13. The test arrangement as claimed in claim 12, featuring a bus multiplexer unit which is arranged between the data processing apparatus and a plurality of test signal units and combines the standard bus systems in the direction of the data processing apparatus into a multiplex standard bus system.
